(19) United States
(12) Patent Application Publication
(10) Pub. No.: US 2007/0012142 A1
(43) Pub. Date: Jan. 18, 2007

(54) Ratchet screwdriver

(76) Inventor: Hsuan-Sen Shiao, Taichung Hsien (TW)

Correspondence Address: LADAS & PARRY LLP, 224 SOUTH MICHIGAN AVENUE, SUITE 1600, CHICAGO, IL, 60604, US

(21) Appl. No.: 11/181,535

(22) Filed: Jul. 14, 2005

(51) Int. Cl. B25B 13/46

(52) U.S. Cl. 81/62; 81/63.1

(57) ABSTRACT

A ratchet screwdriver for a ratchet screwdriver has a ratchet unit including a handle extending along an axis, a positioning seat disposed fixedly on the handle, a ratchet wheel journalled within the positioning seat, and two pawls disposed between the positioning seat and the ratchet wheel. Each of the pawls is formed with a plurality of retaining teeth movable into engagement with ratchet teeth of the ratchet wheel. Two pivot pin units extend parallel to the axis, and are connected respectively to the pawls such that the pawls are rotatable respectively about the pivot pin units. Two resilient members bias respectively the pawls toward the ratchet wheel. A rotary cover is disposed rotatably on the positioning seat, and includes a driving portion that moves each of the pawls between an engagement position and a disengagement position.

### BACKGROUND OF THE INVENTION

1. Field of the Invention

This invention relates to a handle tool, and more particularly to a ratchet screwdriver.

2. Description of the Related Art

U.S. Pat. No. 6,658,970 discloses a ratchet screwdriver, as shown in FIGS. 1 and 2, which includes two pawls 4 and a ratchet wheel 2. Although the ratchet screwdriver can achieve its intended purpose, each of the pawls 4 and engaging teeth 201 of the ratchet wheel 2 must have a relatively large size, thereby resulting in a reduction in the number of the engaging teeth 201 of the ratchet wheel 2. This reduces the operating efficiency of the ratchet wheel 2.

Referring to FIG. 3, another conventional ratchet screwdriver includes a main body 8, a ratchet wheel 9 journalled within the main body 8, and a control device 9′ for controlling a rotational direction of the ratchet wheel 9 relative to the main body 8. The main body 8 has a central accommodating hole 801 mounted with the ratchet wheel 9 positioned therein, and two curved accommodating recesses 802 extending along a circumferential direction of the main body 8. The control device 9′ includes a cover body 901′, two toothed pawls 902′ controlled by the cover body 901′ and disposed respectively within the accommodating recesses 802′, and two springs 903′ imparting biasing forces to the pawls 902′. The cover body 901′ has a fixed pushing block 904′. Each of the pawls 902′ has an inclined surface 905′ in contact with the pushing block 904′. When the cover body 901′ is rotated, the pushing block 904′ moves and separates a selected one of the pawls 902′ from the ratchet wheel 9, thereby allowing for co-rotation of the ratchet wheel 9 with the main body 8. Because each of the pawls 902′ has a plurality of teeth movable into engagement with the ratchet wheel 9, the operating efficiency of the ratchet screwdriver is improved. However, when the pushing block 904′ moves the pawls 902′ within the accommodating recesses 802, the paths of the pawls 902′ are not fixed. As a result, when the pawls 902′ are released from the pushing block 904′ and are then biased by the springs 903′ toward the ratchet wheel 9, it is difficult for the teeth of the pawls 902′ to engage accurately teeth of the ratchet wheel 9. Furthermore, when the inclined surfaces 905′ are machined during manufacture of the pawls 902′, there is a need for high precision. This increases the manufacturing costs of the ratchet screwdriver.

### SUMMARY OF THE INVENTION

The object of this invention is to provide a ratchet screwdriver that can overcome the abovementioned drawbacks associated with the prior art.

According to this invention, a ratchet screwdriver includes a handle extending along an axis and having a front end, and a ratchet unit. The ratchet unit includes:

a positioning seat disposed fixedly on the front end of the handle;

a ratchet wheel journalled within the positioning seat;

two pawls disposed between the positioning seat and the ratchet wheel, each of the pawls having a pivot end, a free end, an annular outer surface that is formed with a plurality of retaining teeth, and a front side that is formed with a projection which extends forwardly therefrom and which is disposed between the pivot end and the free end;

two pivot pin units extending parallel to the axis and connected respectively to the pawls such that the pawls are rotatable respectively about the pivot pin units;

two resilient members for biasing respectively the pawls toward the ratchet wheel, each of the resilient members being disposed between the positioning seat and a corresponding one of the pawls; and

a rotary cover disposed rotatably on the positioning seat and confining the ratchet wheel, the pawls, and the resilient members within the positioning seat, the rotary cover having a driving portion that is movable to contact the projections of the pawls, the rotary cover being operable so that the driving portion of the rotary cover rotates each of the pawls between an engagement position and a disengagement position, the driving portion having an annular outer surface that is eccentric with respect to the axis and that has a pushing section and a non-pushing section, which is located nearer to the axis than the pushing section, each of the pawls being disposed at the engagement position so as to engage the retaining teeth of a corresponding one of the pawls with the ratchet teeth of the ratchet wheel when the non-pushing section of the annular outer surface of the driving portion of the rotary cover comes into contact with the projection of the corresponding one of the pawls, each of the pawls being disposed at the disengagement position so as to remove the retaining teeth of the corresponding one of the pawls from the ratchet teeth of the ratchet wheel when the pushing section of the annular outer surface of the driving portion of the rotary cover comes into contact with the projection of the corresponding one of the pawls.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a fragmentary exploded perspective view of a conventional ratchet screwdriver disclosed in U.S. Pat. No. 6,658,970;

FIG. 2 is a sectional view of the conventional ratchet screwdriver shown in FIG. 1;

FIG. 3 is a sectional view of another conventional ratchet screwdriver;

FIG. 4 is a sectional view of the preferred embodiment of a ratchet screwdriver according to this invention;

FIG. 5 is a partly sectional, exploded perspective view of the preferred embodiment, shown in a state in which a screwdriver bit has been removed;

FIG. 6 is a sectional view taken along line 6-6 in FIG. 4;

FIG. 7 is a sectional view taken along line 7-7 in FIG. 4; and

FIG. 8 is a sectional view of the preferred embodiment, illustrating how a rotary cover is operated to rotate a pawl from an engagement position to a disengagement position.

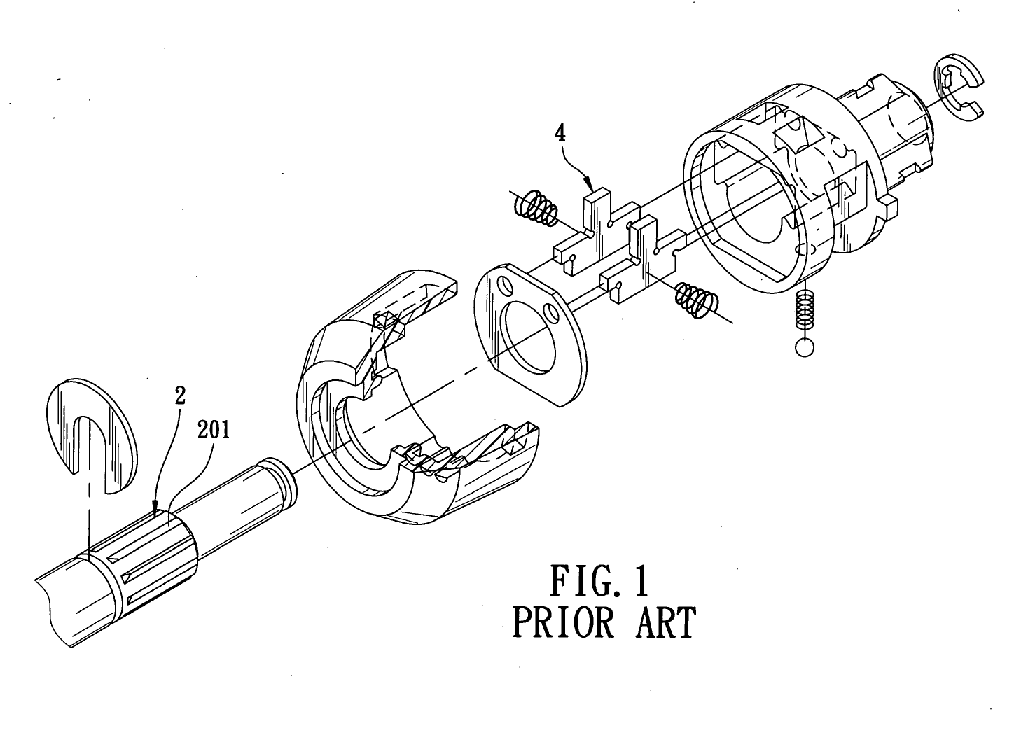

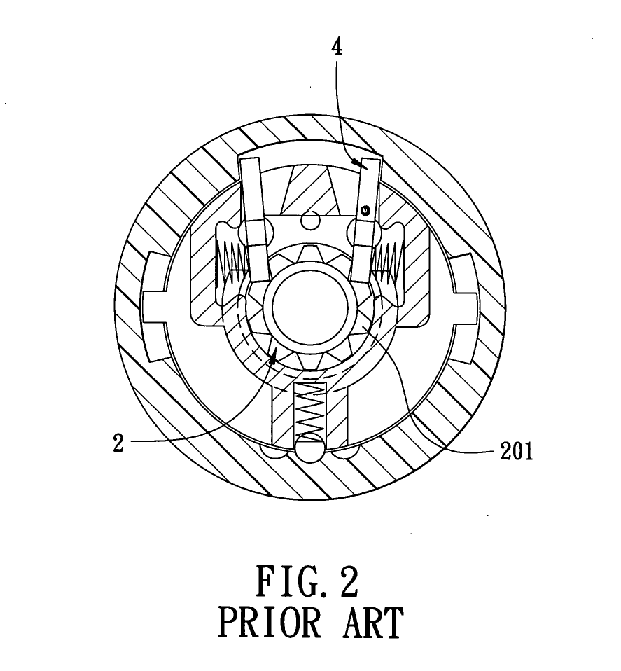

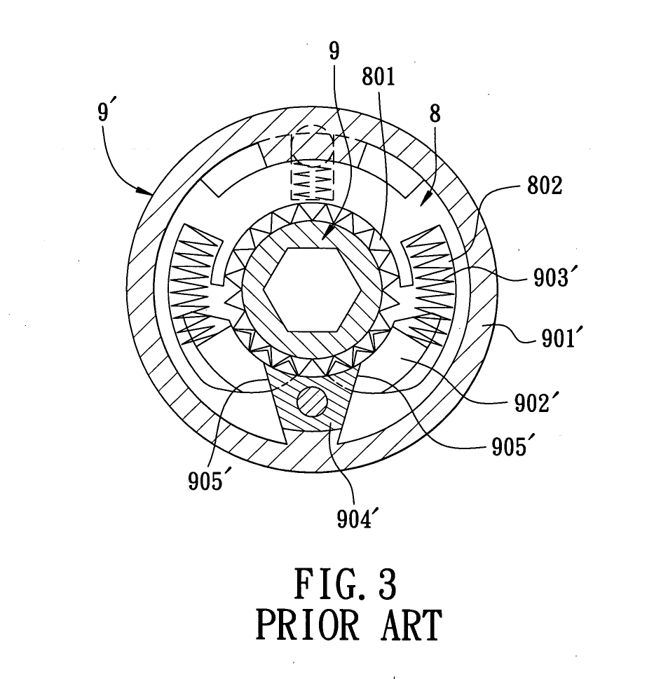

### DETAILED DESCRIPTION OF THE PREFERRED EMBODIMENT

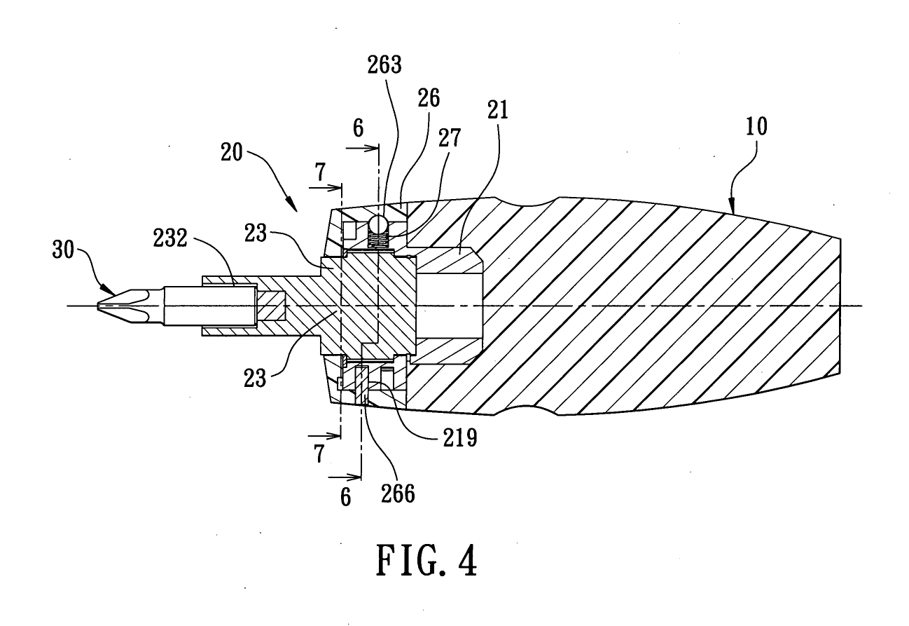

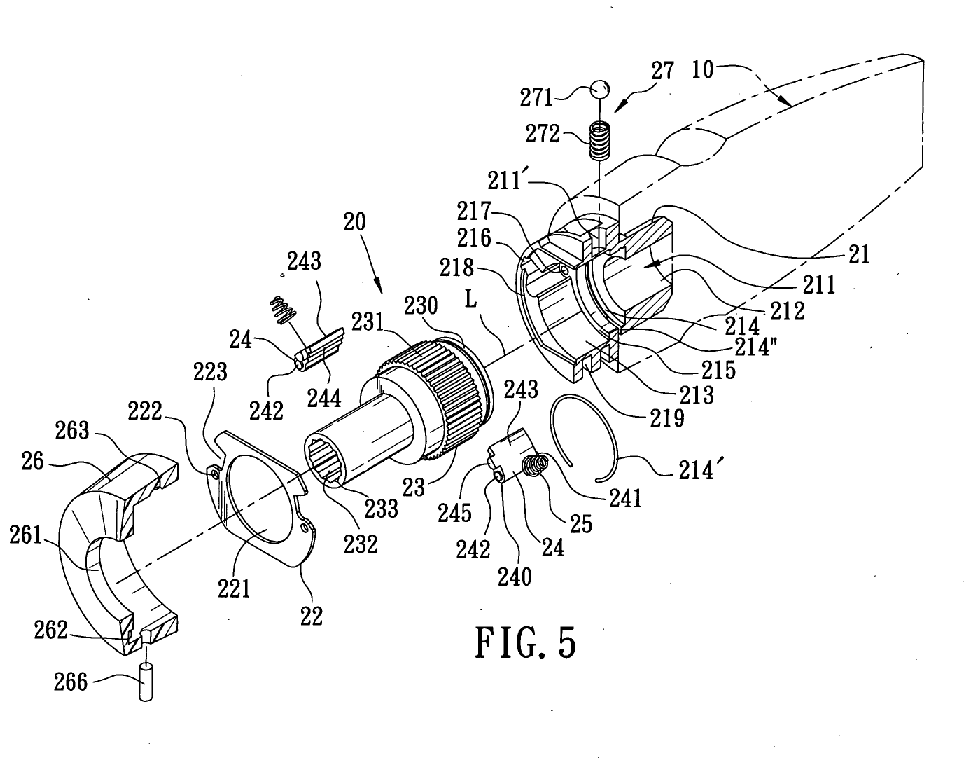

Referring to FIGS. 4 and 5, the preferred embodiment of a ratchet screwdriver according to this invention includes a handle 10, a ratchet unit 20, and a replaceable screwdriver bit 30.

The handle 10 extends along an axis (L).

The ratchet unit 20 includes a positioning seat 21, a position-limiting plate 22, a ratchet wheel 23, two pawls 24, two resilient members 25, a rotary cover 26 and a positioning unit 27.

The positioning seat 21 is disposed fixedly on a front end of the handle 10, and has a stepped hole 211 and a cylindrical hole 211′. The stepped hole 211 has a small-diameter portion 212 disposed in proximity to the handle 10, a large-diameter portion 213 disposed in front of the small-diameter portion 212 and having a diameter greater than that of the small-diameter portion 212, and a middle portion 214 interconnecting the small-diameter and large-diameter portions 212, 213. The positioning seat 21 further has a shoulder 215 defined between the large-diameter and middle portions 213, 214 of the stepped hole 211. The large-diameter portion 213 has opposing grooves 216. A C-shaped retaining ring 214′ is disposed within the middle portion 214, and is received within an annular groove 214″ in an inner wall of the positioning seat 21 defining the middle portion 214. The shoulder 215 has two first pivot holes 217 aligned respectively with the grooves 216. A front end of the positioning seat 21 has an end surface that is formed with a recess 218, and an annular outer surface that is formed with a limiting slot 219. The limiting slot 219 has two closed ends (not shown).

The position-limiting plate 22 is fitted within the recess 218 in the positioning seat 21, and has a central hole 221 aligned with the stepped hole 211 in the positioning seat 21, two second pivot holes 222 formed respectively through left and right side portions of the position-limiting plate 22, and two notches 223 disposed respectively in proximity to the second pivot holes 222.

The ratchet wheel 23 is disposed within the large-diameter and middle portions 213, 214 of the stepped hole 211 in the positioning seat 21, and has a front end journalled within the position-limiting plate 22, and a rear end journalled within the retaining ring 214′. The retaining ring 214′ is received within an annular groove 230 in an annular outer surface of the ratchet wheel 23. The ratchet wheel 23 has an annular outer surface that is formed with a plurality of ratchet teeth 231 disposed within the large-diameter portion 213 of the stepped hole 211, and a non-circular central bore 232. The central bore 232 is in the form of a spline hole, and is defined by twelve spline internal teeth 233 so as to engage a hexagonal head of the screwdriver bit 30.

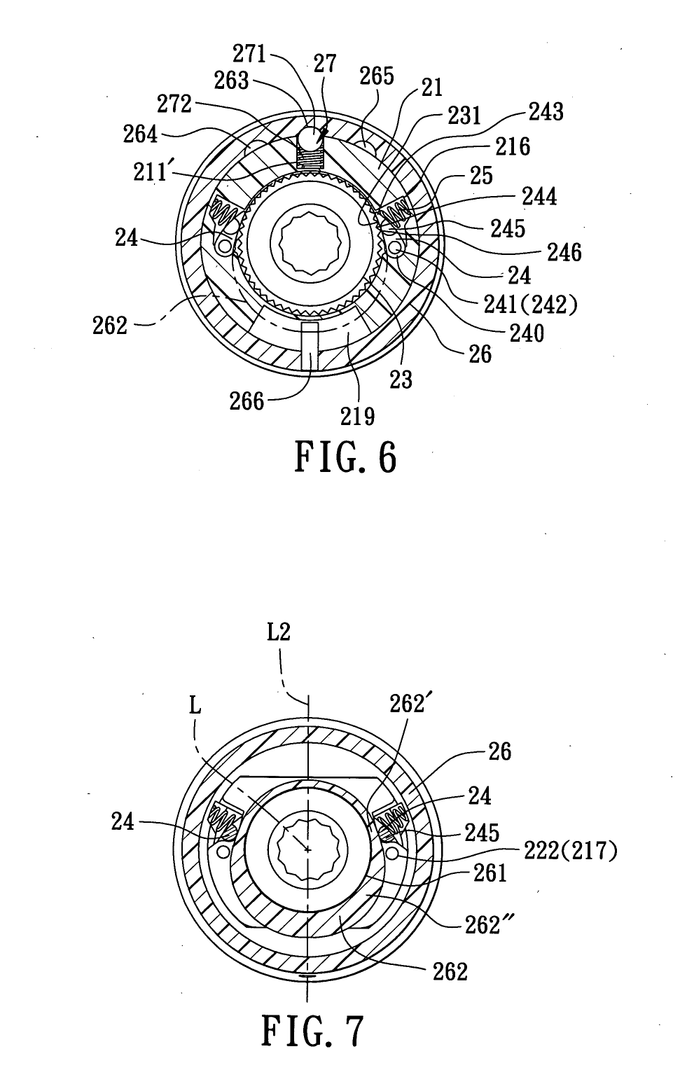

With further reference to FIG. 6, the pawls 24 are disposed between the positioning seat 21 and the ratchet wheel 23. Each of the pawls 24 has a pivot end 240 that is formed with a pivot pin unit. Each of the pivot pin units includes a first pin 241 formed integrally with a rear side of the corresponding pawl 24 and disposed rotatably within the corresponding first pivot hole 217 in the shoulder 215, and a second pin 242 formed integrally with a front side of the corresponding pawl 24 and disposed rotatably within the corresponding second pivot hole 222 in the position-limiting plate 22. The first and second pins 241, 242 of each of the pivot pin units are aligned with each other, and extend parallel to the axis (L). As such, each of the pawls 24 is rotatable about the corresponding first and second pins 241, 242. Each of the pawls 24 further has a free end 243 that is formed with a plurality of retaining teeth 244, and a projection 245, which extends forwardly from the front side of the corresponding pawl 24 and through the corresponding notch 223 in the position-limiting plate 22 and which is disposed between the pivot end 240 and the free end 243 of the corresponding pawl 24. Each of the projections 245 has a semicircular cross section to thereby be formed with a curved surface 246.

Each of the resilient members 25 is in the form of a coiled compression spring, and is disposed within the corresponding groove 216 so as to bias the free end 243 of the corresponding pawl 24 toward the ratchet wheel 23.

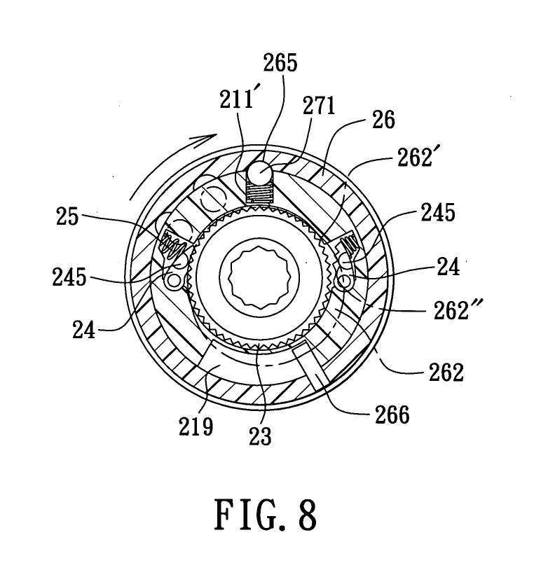

With further reference to FIG. 7, the rotary cover 26 is in the form of a tubular sleeve, and is sleeved rotatably on the positioning seat 21 so as to confine the ratchet wheel 23, the pawl members 24 and the resilient members 25 within the positioning seat 21. The rotary cover 26 is provided with a fixed pin 266 extending into the limiting slot 219 in the positioning seat 21 so as to limit a rotational angle of the rotary cover 26 relative to the positioning seat 21 within a predetermined range. The rotary cover 26 has a central hole 261, and is sleeved on the positioning seat 21 and the ratchet wheel 23. A front end portion of the rotary cover 26 is formed with an annular driving portion 262 that is adjacent to the position-limiting plate 22. An annular outer surface of the driving portion 262 is eccentric with respect to the axis (L) , and has a non-pushing section 262′ and a pushing section 262″. The non-pushing section 262′ is located nearer to the axis (L) than the pushing section 262″. The curved surface 246 of the projection 245 of each of the pawls 24 is in slidable contact with the non-pushing section 262′ or the pushing section 262″ of the annular outer surface of the driving portion 262 of the rotary cover 26. An inner surface of the rotary cover 26 is formed with first, second and third positioning holes 263, 264, 265. The first positioning hole 263 is disposed between the second and third positioning holes 264, 265. The shape of the driving portion 262 is symmetrical with respect to a line (L2) (see FIG. 7) that perpendicularly intersects with the axis (L) to thereby extend along a radial direction of the rotary cover 26. The driving portion 262 is in contact with the projections 245 of the pawls 24. Upon rotation of the rotary cover 26 on the positioning seat 21, the driving portion 262 can rotate each of the pawls 24 between an engagement position shown in FIG. 6, where the retaining teeth 244 of the corresponding pawl 24 engage the ratchet teeth 231 of the ratchet wheel 23, and a disengagement position shown in FIG. 8, where the retaining teeth 244 of the corresponding pawl 24 are removed from the ratchet teeth 231 of the ratchet wheel 23.

The positioning unit 27 is disposed within the cylindrical hole 211′ in the positioning seat 21, and includes a retainer 271 in the form of a ball, and a spring 272 for biasing the retainer 271 to project from the cylindrical hole 211′.

Referring to FIGS. 6 and 7, when the retainer 271 engages the first positioning hole 263, the non-pushing section 262′ contacts the projections 245 of the pawls 24. As such, the pawls 24 engage the ratchet wheel 23 so as to allow for co-rotation of the ratchet wheel 23 with the positioning seat 21 in either a clockwise or counter clockwise direction.

Referring to FIGS. 5 and 8, when the rotary cover 26 is rotated on the positioning seat 21 in a counterclockwise direction so as to engage the retainer 271 with the third positioning hole 265, the left pawl 24 engages the ratchet wheel 23, whereas the right pawl 24 separates from the ratchet wheel 23. As a result, the ratchet wheel 23 can co-rotate with the positioning seat 21 only in a clockwise direction, as shown by the arrow in FIG. 8.

Conversely, if the rotary cover 26 is rotated on the positioning seat 21 in a clockwise direction so as to engage the retainer 271 with the second positioning hole 264, the left pawl 24 will separate from the ratchet wheel 23, whereas the right pawl 24 will engage the ratchet wheel 23. This allows for co-rotation of the ratchet wheel 23 with the positioning seat 21 only in a counterclockwise direction.

The ratchet screwdriver of this invention has the following advantages:

1. Each of the pawls 24 is formed with a plurality of retaining teeth 244 movable into engagement with ratchet teeth 231 of the ratchet wheel 23. This allows for close engagement between the ratchet wheel 23 and the pawls 24. Furthermore, because the size of the retaining teeth 244 is small, an idle rotation angle of the ratchet screwdriver can be reduced during use, thereby improving the operating efficiency of the ratchet screwdriver.

2. Each of the pawls 24 is rotatable about the corresponding first and second pins 241, 242. Because the first and second pins 241, 242 are all journalled in the positioning seat 21, the retaining teeth 244 of the pawls 24 can engage accurately the ratchet teeth 231 of the ratchet wheel 23.

With this invention thus explained, it is apparent that numerous modifications and variations can be made without departing from the scope and spirit of this invention. It is therefore intended that this invention be limited only as indicated by the appended claims.

I claim:

1. A ratchet screwdriver comprising:
a handle extending along an axis and having a front end; and
a ratchet unit including
a positioning seat disposed fixedly on said front end of said handle,
a ratchet wheel journalled within said positioning seat,
two pawls disposed between said positioning seat and said ratchet wheel, each of said pawls having a pivot end, a free end that is formed with a plurality of retaining teeth, and a front side that is formed with a projection, which extends forwardly therefrom and which is disposed between said pivot end and said free end,
two pivot pin units extending parallel to said axis and connected respectively to said pawls such that said pawls are rotatable respectively about said pivot pin units,
two resilient members for biasing respectively said pawls toward said ratchet wheel, each of said resilient members being disposed between said positioning seat and a corresponding one of said pawls, and
a rotary cover disposed rotatably on said positioning seat and confining said ratchet wheel, said pawls, and said resilient members within said positioning seat, said rotary cover having a driving portion that is movable to contact said projections of said pawls, said rotary cover being operable so that said driving portion of said rotary cover rotates each of said pawls between an engagement position and a disengagement position, said driving portion having an annular outer surface that is eccentric with respect to the axis and that has a pushing section and a non-pushing section, which is located nearer to said axis than said pushing section, each of said pawls being disposed at said engagement position so as to engage said retaining teeth of a corresponding one of said pawls with said ratchet teeth of said ratchet wheel when said non-pushing section of said annular outer surface of said driving portion of said rotary cover comes into contact with said projection of the corresponding one of said pawls, each of said pawls being disposed at said disengagement position so as to remove said retaining teeth of the corresponding one of said pawls from said ratchet teeth of said ratchet wheel when said pushing section of said annular outer surface of said driving portion of said rotary cover comes into contact with said projection of the corresponding one of said pawls.

2. The ratchet screwdriver as claimed in claim 1, wherein said positioning seat has a stepped hole, said stepped hole having a small-diameter portion disposed in proximity to said handle, and a large-diameter portion disposed in front of said small-diameter portion and having a diameter greater than that of said small-diameter portion, said positioning seat further having a shoulder disposed between said small-diameter and large-diameter portions of said stepped hole, said ratchet wheel being disposed within said large-diameter portion of said stepped hole in said positioning seat, said shoulder being formed with two first pivot holes, said positioning seat further having a front end surface that is formed with a recess, said ratchet unit further including a position-limiting plate that is fitted within said recess in said front end surface of said positioning seat and that is sleeved rotatably on said ratchet wheel, said position-limiting plate being formed with two second pivot holes aligned respectively with said first pivot holes in said shoulder of said positioning seat, each of said pawls having front and rear sides, each of said pivot pin units including a first pin that is formed integrally with said rear side of a corresponding one of said pawls and that is disposed rotatably within a corresponding one of said first pivot holes in said shoulder of said positioning seat, and a second pin that is formed integrally with said front side of the corresponding one of said pawls and that is disposed rotatably within a corresponding one of said second pivot holes in said position-limiting plate.

3. The ratchet screwdriver as claimed in claim 2, wherein said ratchet unit further includes a positioning unit, said positioning unit including a spring-biased retainer disposed on said positioning seat, said rotary cover further having three positioning holes and being rotatable on said positioning seat so as to engage said spring-biased retainer with a selected one of said positioning holes.

4. The ratchet screwdriver as claimed in claim 1, wherein said projection of each of said pawls is formed with a curved surface in slidable contact with said annular outer surface of said driving portion of said rotary cover.

5. The ratchet screwdriver as claimed in claim 1, wherein said ratchet wheel has a non-circular central bore, said ratchet screwdriver further comprising a screwdriver bit inserted into said central bore in said ratchet wheel such that rotation of said screwdriver bit relative to said ratchet wheel is prevented.
